(19) United States
(12) Patent Application Publication
(10) Pub. No.: US 2006/0090528 A1
(43) Pub. Date: May 4, 2006

(54) Interchangeable ornamented key system

(76) Inventor: Paul Forrest Moening, Los Angeles, CA (US)

Correspondence Address: Paul F. Moening, 9906 Girla Way, Los Angeles, CA, 90064, US

(21) Appl. No.: 10/979,500

(22) Filed: Nov. 1, 2004

(51) Int. Cl. E05B 19/04

(52) U.S. Cl. 70/395; 70/408

(57) ABSTRACT

An interchangeable key system having a non-spheroidal head, where the head includes a front surface and a back surface, a side surface that spans the periphery, a top end, a bottom end that is opposite the top end, a cavity in either the front or the back surface, and an opening in the side surface, at the bottom end, connecting to the cavity. The key system also includes a blank having a blade at a distal end and a projection at a proximal end; where the blade is adapted for insertion into a lock, and at least a portion of the projection is adapted for insertion into the cavity. The key system also includes means for removably connecting the blank and the head together, such that the blank is generally fixed relative to the head when the two are connected. Faceplates may be attached to the front and back surfaces for ornamental enhancement of the system.

### CROSS-REFERENCE TO RELATED APPLICATIONS

Not applicable.

### FEDERALLY SPONSORED RESEARCH

Not applicable.

### SEQUENCE LISTING OF PROGRAM

Not applicable.

### FIELD OF THE INVENTION

This invention relates to devices for use in connection with keys such as those typically used for operating residential and commercial door locks, car locks and car ignitions, and is particularly, but not exclusively, concerned with a system for ornamenting that portion of a key commonly known as the head, the bow, or the tab.

### BACKGROUND OF THE INVENTION

Keys, as commonly used for operating locks installed on doors and for operating automobiles, are ubiquitous and come in many types, but generally are unadorned and have quite similar appearances. The relatively similar and generic appearance of keys often results in delays in ascertaining the correct key for a lock when there are more than a few keys on a keychain or other key holder. Difficulty in locating a particular key results in wasted time and needless frustration, and can also jeopardize safety.

In the marketplace, although there are a number of add-on devices for differentiating keys, there is little available in terms of design-oriented or fashionable key designs. Some design-conscious consumers desire keys that are stylish, are unique, and that satisfy their need for self-expression. However, due to how often it is necessary to change keys due to changing of locks, moving residences, or changing vehicles, there is a disincentive to purchase anything but inexpensive, unadorned keys. That is because the average consumer would not want to pay a premium for an ornamented key that would eventually have to be discarded when the consumer moved residences, changed door locks or bought a new car. For ornamented key styles to be economically practical from a consumer's perspective, there is a need for a mechanism and system to provide for interchangeability of the key or the key blade from the ornamented key part, so that the ornamented key part can be kept indefinitely and fitted with new blades.

Several types of multi-part or hinged ornamental tab devices have been proposed, in which a key with a standard type key head is enveloped by a hinged or box-like case, or sandwiched between plates. For example, U.S. Pat. No. 4,826,002 proposes a number of configurations of a two-part or hinged case that envelops a standard tabbed key. That design relies on intake walls, or sponge-like inserts, to lock the shaft in place so as to prevent rotary movement of the shaft relative to the case. Consequently, if the key used is of a thickness that is less than the opening in the peripheral wall of the case, there could be undesired displacement or play between the shaft and the case. Similarly, U.S. Pat. Nos. 4,349,975, 4,102,166, and 2,759,280 disclose variants of a sandwich-construction key bow cover, which although utilitarian for means of providing enhanced identification capabilities for keys, fall short of providing a refined aesthetic finish to a key. Other multi-piece constructions are disclosed in U.S. Pat. Nos. 4,901,548, 5,383,345, and 6,651,470, which require relatively complicated construction, and have limited flexibility for the shape, ornamentation, and interchangeability of the key head.

### SUMMARY OF THE INVENTION

Shortcomings of prior key systems may be overcome with an embodiment of the present invention.

It is an object of the present invention to provide a novel interchangeable ornamented key system, whereby a key head is capable of interchangeably accepting a variety of key blank profiles and configurations, thereby enhancing the aesthetic and fashionable appearance of a key, and upgrading the perceived quality and uniqueness of a key.

One embodiment of the present key system has a non-spheroidal head, where the head includes a front surface and a back surface, a side surface that spans the periphery, a top end, a bottom end that is opposite the top end, a cavity in either the front or the back surface, and an opening in the side surface, at the bottom end, connecting to the cavity. The key system also includes a blank having a blade at a distal end and a projection at a proximal end; where the blade is adapted for insertion into a lock, and at least a portion of the projection is adapted for insertion into the cavity. The key system also includes means for removably connecting the blank and the head together, such that the blank is generally fixed relative to the head when the two are connected. Faceplates, or medallions, may be attached to the front and back surfaces for ornamental enhancement of the system.

### BRIEF DESCRIPTION OF THE DRAWINGS

FIG. 1 is an exploded perspective view of an exemplary key system, according to the present invention;

FIG. 2A is a perspective view of the key system;

FIG. 2B is a partially assembled perspective view of the key system;

FIG. 3A is a perspective view of one configuration of the front side of a faceplate;

FIG. 3B is a perspective view of one configuration of the back side of a faceplate;

FIG. 4A is a plan view of one configuration of the obverse face of the key head;

FIG. 4B is a plan view of one configuration of the reverse face of the key head;

FIG. 5A is a perspective view of one configuration of a collar that may be used in the exemplary key system;

FIG. 5B is a perspective view of another configuration of a collar that may be used in the exemplary key system; and

FIG. 6 is a perspective view of the key system.

### DESCRIPTION OF INVENTION

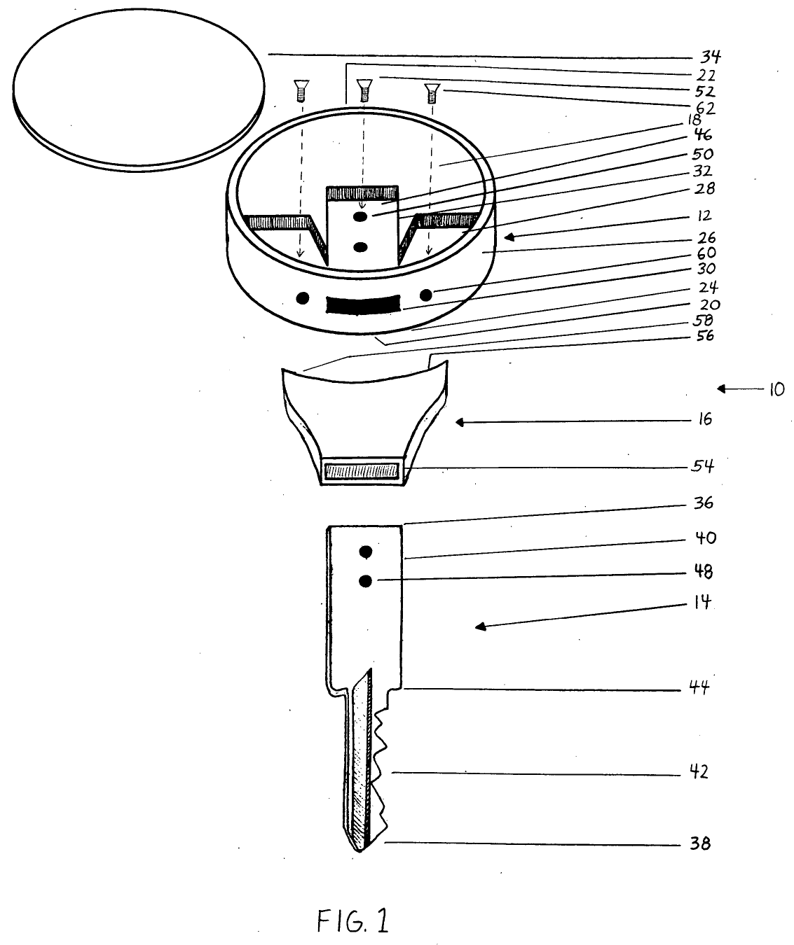

FIG. 1 shows an exploded perspective view of an exemplary interchangeable ornamented key system. The key system 10 generally comprises a head 12, a blank 14, and a collar 16.

The head 12 is shown having a single-piece construction with an obverse face 18, a reverse face 20 facing opposite the front, a top end 22, and a bottom end 24 opposite the top. In the configuration of the head depicted, a side surface 26 spans the periphery of the head and is generally disposed between the obverse and the reverse faces. The obverse face 18 of the head is fashioned with a cavity 28. The cavity generally provides access for attaching the blank 14 and the collar 16 to the head 12. An opening 30 in side surface 26 connects to the cavity. Within the cavity is a slot 32 to receive a portion of blank 14 for attachment. The head can be formed in various utilitarian shapes and configurations, particularly non-spheroidal shapes that promote enhanced gripping and provide reduced volume and bulk. The head can be made from any suitable materials, including metal, alloy, wood, glass, stone, plastic, resin, enamel, composite, fiber-reinforced material, rubber, ivory, bone, leather, any other suitable natural or man-made material, or any combination of materials. Although the faces themselves can be configured to have any desired design, image, or texture, the preferred ornamentation of the system is decorative faceplates 34, or medallions, that may be attached to the faces 18 and 20. These faceplates may be of virtually any shape (typically matching the shape of the key face to which they attach), and may have any type of pattern, design, texture, indicia, or advertising. The faceplates not only add ornamentation, potential for customization, and an element of style to the key system, but also, especially on the obverse face 18, serve to cover the cavity, the exposed attachment mechanisms, and any other void. The side surface of the key head can also be ornamented, and can be configured to have raised markings that help a user to orient the key in low-light conditions.

The blank 14 is configured to be removably attachable to the head. The blank has a proximal end 36 and a distal end 38. The proximal end includes a projection 40, which is designed to fit within the collar 16 and, in this embodiment, to extend through the collar and fit through opening 30 and within slot 32. The distal end comprises a conventional key blade 42, which is the portion of a key that engages the lock. The blade portion can have any desired profile, configuration or features, including but not limited to, the profiles and configurations found on the blades of the most common brands of commercial key blanks found in the marketplace, such as those sold by Kwikset, Schlage, and Titan. The blank shown also includes a shoulder 44, positioned between the proximal and distal ends, which is a common component of many keys to properly position the blade within a lock.

To attach key blank 14 to key head 12, projection 40 may be inserted through opening 30, and butted into slot 32. Projection 40 may then be attached to the base 46 of the slot by any suitable means, including fasteners and adhesives. In utilizing fasteners, projection 40 may be fashioned with one or more apertures 48 (shown with two), and base 46 of the slot would have matching female-threaded receiving holes 50, such that when the projection is inserted fully into slot 32, projection holes 48 align with receiving holes 50. Fasteners 52, shown as screws, may then be inserted through holes 48 and screwed into receiving holes 50. The design is such that installed key blanks may be easily removed and replaced by new blanks with simple tools. Note that slot 32 could be fashioned in any shape, including that of a round or rectangular key head shape that could accept a conventional key blank. Note also that if the key blank is designed with a projection 40 that has a portion that is wider than opening 30 (such as the round key head shape mentioned above), the system can be assembled by inserting the blade portion through opening 30 from the inside of the cavity.

Although the key system is fully operable with only the blank attached to the head, a collar 16 may be slipped over the attached key blank 14, and fastened to head 12 to contribute to a more refined and stylistic design, and to add further attachment options. The collar can have a variety of shapes and configurations. The collar is shown in FIG. 1 as having a shape that conforms to the bottom end of the head. The collar generally comprises a hollowed neck 54 that is adapted to receive the projection 40 of the blank, and a support base 56 that extends from the neck and is designed to attach the collar to the head.

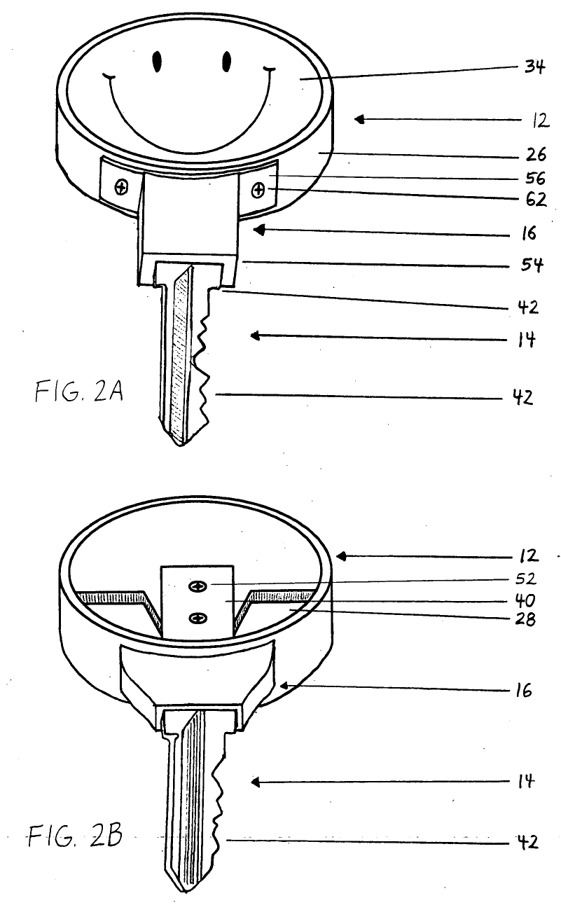

Collar 16 may be configured so that it may be attached to the head with fasteners that are either visible or hidden. The configuration shown in FIG. 1 has hidden fasteners. Collar 16 is fashioned with one or more blind collar shafts 58, which in this configuration would be female-threaded shafts. The collar can be secured to the key head by positioning the support base up against the head, aligning collar shafts 58 with corresponding apertures 60 in side surface 26, and then inserting fasteners 62, shown here as screws, from the inside of the key head, through holes 60, and screwing firmly into collar holes 58. In an alternative configuration, shown in FIG. 2A, collar shafts 58 would extend completely through support base 56. The shafts would then be accessible from the exterior of the collar, allowing the collar to be attached by inserting fasteners (shown as screws) through the shafts and screwing firmly into side surface holes 60. In this alternative configuration, the retaining fasteners 62 would be visible from the exterior of the system. In addition to fasteners such as screws, bolts, rods, or the equivalent being used to secure collar 16 to the key head, adhesives, friction fit, welds and soldering could also be used to attach the collar to either the key blank or to the key head.

Following the attachment of the key blank to the head, and the optional attachment of the collar, faceplates 34 can be attached to the faces of the head, which serve to provide ornamentation and customization to the key head, as well as to hide the cavity and attachment mechanisms on the obverse side of the head, and any voids that may be fashioned on the reverse side.

When a user of the key system needs to change their key for whatever reason (such as moving residences, changing their locks, etc.), the key system 10 allows for a new key blank to be installed, while allowing the user to keep and re-use their key head. The faceplate from the obverse side may be removed, followed by removal of the collar 16 and the blank 14 from the head 12. A new key blank can then be attached to the head. Therefore, the key system allows a user to customize their key head and not lose the investment in the head or the sentimental value that may be attached to the head.

The collar and the key head do not interfere with the ability of a locksmith to cut the key blank. The key blank, according to the present invention, may be cut by a locksmith in either the pre-mounted state or after the key blank has been installed into the key system, using most currently available commercial key cutting machines. Note that for a key blank configured with a shoulder intended to be used with a collar, key blank 14 should be constructed and mounted so that shoulder 44 extends even to or past the end of collar neck 54, so that the cutting of the key will not be impaired and the key will be fully operable in a lock.

FIGS. 2A and 2B show assembled perspective views of the key system. Note that in FIG. 2B, the faceplate has not been depicted, so as to show the attachment mechanism for the blank and the collar. This figure also shows the configuration of the collar wherein the collar is attached to the head with hidden fasteners. FIG. 2A shows the addition of a decorative faceplate, as well as depicting the collar with the configuration employing exposed fasteners.

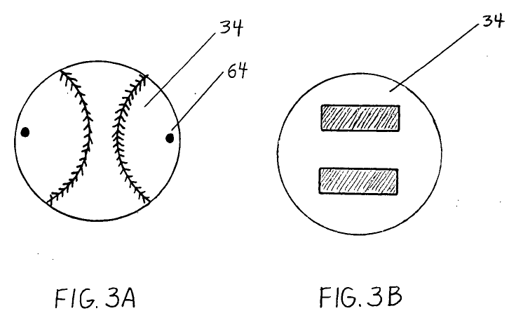

FIGS. 3A and 3B show plan views of the front side, and back side, respectively, of faceplates 34. The view of the front side of a sample faceplate shows small apertures 64 on either side of the face by which the faceplate could be attached to the head by fasteners. The view of the back side of faceplate 34 depicts slightly recessed areas on which adhesive could be placed, and the faceplate attached to the head, without raising the faceplate significantly above the surface of the head. Typically, the faceplate would be constructed of metal, with a pattern, indicia or design incorporated by stamping, casting, etching, enameling, lithographing or other type or combination of manufacture and surface treatment. The faceplate could be fashioned of nearly any material, including metal alloy, wood, glass, stone, plastic, resin, enamel, composite, fiber-reinforced material, rubber, ivory, bone, leather, any other suitable natural or man-made material, or any combination of materials. The faceplates may be of virtually any shape (with the outline typically matching the shape of the key face to which they attach), and may have any type of pattern, design, texture, indicia, and advertising. Faceplates may be attached to the key head by a variety of methods, including adhesives, fasteners such as screws, bolts, rods, or pins, snap-in or friction fit, and integral male screw threads on the bottom or edges of the faceplates which could screw into corresponding female threads on head 12. Because faceplates can be configured to be relatively easy to detach from the head, a user can readily change the look, style, message or design of a key by installing new faceplates onto the head.

Note that the faceplate on the open, obverse face 18 of head 12 will be affixed after the key blank and collar have been secured to the key head. The faceplate on the obverse side covers access to the mechanism attaching the blank to the head, and so would be removed each time that the key blank is changed. Therefore an attachment mechanism that is convenient to remove is most appropriate for this faceplate. The faceplate that is affixed to the reverse side of the key head will only need to be removed if an owner should decide to change the ornamentation of the key head, and thus may be attached to the head by a method that is less easily removable than that used for the obverse face.

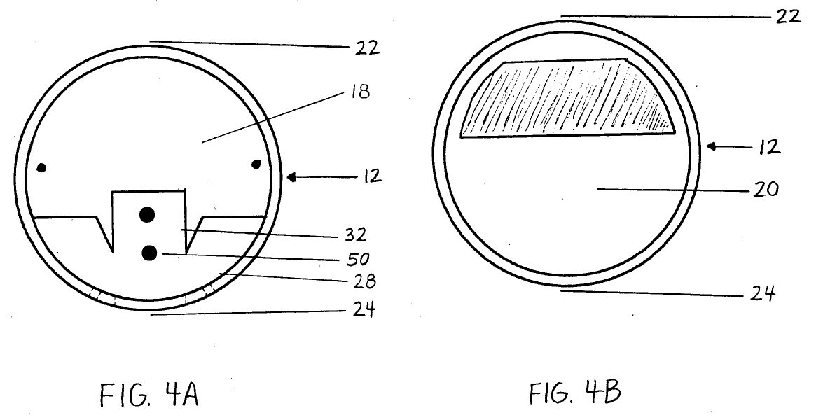

FIGS. 4A and 4B show plan views of the obverse face 18 and the reverse face 20, respectively, of head 12. The cavity 28 within the obverse face, and slot 32, may be a variety of shapes and configurations. They may be varied depending on a number of factors, including the shape of the key blank projection to be used with the head, the type of attachment mechanism for the collar (external or internal screws), the type of attachment mechanism for the faceplates, and the desired weight and balance of the head. Additional cavities, or voids, may be made elsewhere in either face if weight reduction of the head is desired, such as is shown in the figure of the reverse face in FIG. 4B. In the configuration shown for the obverse face, two receiving holes 50 are shown for attaching a blank, and two smaller threaded holes are shown at either side for attaching a faceplate. On the reverse face, no explicit faceplate attachment method is indicated, although a suitable adhesive applied to the raised portions of the face would securely attach the faceplate.

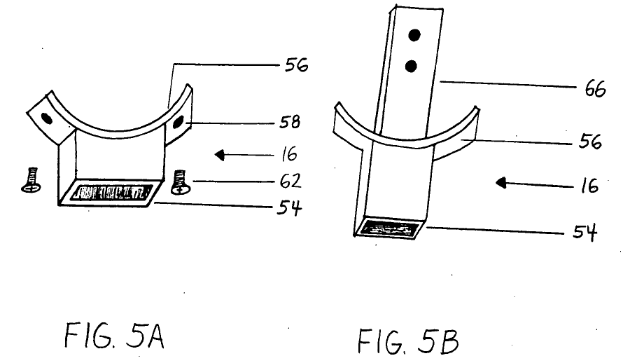

FIGS. 5A and 5B present perspective views of two configurations of collar 16, according to the present invention. FIG. 5A shows the collar having shafts which extend through support base 56, through which fasteners can be inserted and attached to the head. This embodiment would have exposed fasteners visible from the exterior, with said fasteners attaching to the key head through side surface apertures 60. The apertures would have to be modified accordingly to engage external fasteners 62. FIG. 5B shows the collar configured to have an extension 66, which extends out from the support base and in a direction opposite to the neck. The collar extension 66 comprises one or more apertures, through which the extension can be attached to the key head, similar to the mechanism by which projection 40 is attached to the head. In such a configuration, the neck 54 of the collar would be fashioned with a terminated hollow shaft, rather than a hollow shaft running entirely through the neck, as in the prior alternative. The projection 40 of the blank would be fitted into the neck of the collar and attached by any suitable method, including adhesive, interference fit, or fastener. The collar extension would then be inserted through opening 30, fitted into slot 32 and the collar attached to the head with fasteners or other suitable method. Thus, the relative configurations and uses of the collar and the blank can be varied to accommodate the desires of different users and manufacturers without departing from the scope of the invention.

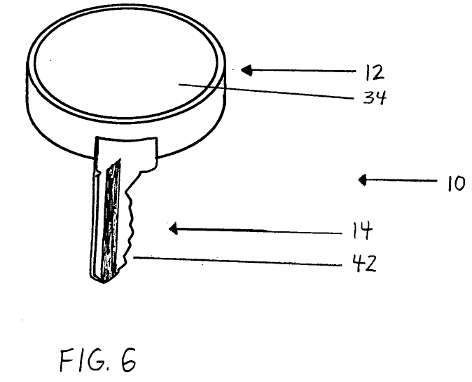

As noted previously, the key system 10 can be beneficially used without a collar. FIG. 6 shows a perspective view of another exemplary embodiment of the exemplary key system in which the system is configured without a collar. Due to the secure means by which the blank can be attached to key head 12 within the cavity of the head, the absence of the collar does not result in appreciable mechanical or holding weakness. Rather, the presence of a collar results primarily in a different aesthetic look, as well as serving to hide any gaps that may be apparent when fitting a thinner key blank inside a thicker standardized opening 30 in side surface 26 of the head. Note that for head 12 in this invention, because it is an object of the invention for the key head to be interchangeable with many different types of key blades, and because there are a wide variety of key blank profiles and types currently available in the market which vary in blade thickness (e.g., a standard Schlage SC-1 profile is slightly thicker than some other popular commercial blank profiles), opening 30 should be of a standardized dimension that has sufficient thickness so that it can accommodate many different types of key blanks. In constructing a one-size-fits-all opening, key blank profiles thinner than the opening will show gaps between the edges of the blank and the edges of the opening when the blank is mounted to the key head without a collar. Such a gap my be aesthetically undesirable to some, and could accumulate dirt under normal usage conditions. To minimize gaps, the key blanks can be manufactured with a uniform projection thickness and dimension, which could be calibrated to specifically fit the dimensions of the standardized opening. The additional usage of a collar designed for each key blank profile will also effectively hide any gap.

In addition to the specific features and embodiments described above, it is understood that the present invention includes all equivalents to the structures and features described herein, and is not to be limited to the disclosed embodiments. For example, the shapes and configurations of the collar and the projection, as well as the slot and the opening, can be easily varied to suit users' preferences. A number of the specific means disclosed for achieving a removable attachment between the blank and the head, the blank and the collar, and the collar and the head, can likewise be varied to include all known types of fasteners, clamps, adhesives, and other suitable combinations of devices and methods that can be used to achieve the desired attachment. The same flexibility for practicing the invention is true with respect to the particular materials and amount of materials used to construct the various portions of the system. Moreover, additional features can be added to the key system, such as including key ring attachments or apertures in the head to allow the key system to be placed on the user's key ring, or incorporating electronic chips or mechanisms, such as ignition transponder or anti-theft components for automobiles. Accordingly, individuals skilled in the art to which the present key system pertains will understand that variations and modifications to the embodiments described can be used beneficially without departing from the scope of the invention.

1. An interchangeable key head system, wherein a key head is capable of being fitted with one or more key blade types, comprising:
a non-spheroidal head, wherein the head comprises a front surface and a back surface, a side surface that spans the periphery, a top end, a bottom end that is opposite the top end, a cavity in either the front or the back surface, and an opening in the side surface, at the bottom end, connecting to the cavity;
a blank comprising a blade at a distal end and a projection at a proximal end; wherein the blade is adaptable for insertion into a lock, and at least a portion of the projection is adapted for insertion into the cavity;
means for removably connecting the blank and the head together, such that the blank is generally fixed relative to the head when the two are connected; and
faceplates that may be attached to the front and back surfaces of the head.

2. The key system of claim 1 wherein the head further comprises one or more apertures in the base of the cavity, and the projection comprises one or more apertures.

3. The key system of claim 2 wherein the projection is inserted into the cavity a distance that extends at least as far as the apertures in the head so that the apertures in the projection align with the apertures in the head, such that a fastener can be placed through each aperture in the projection and into the head to secure the projection within the cavity.

4. (canceled)

5. The key system of claim 1 wherein the projection is secured within the cavity by attachment means such as adhesives, clamping, interference fit, welding, soldering, and/or brazing.

6. (canceled)

7. (canceled)

8. The key system of claim 1, wherein the system further comprises a collar, wherein the collar comprises a hollowed neck adapted to receive the blank and a support base that extends from the neck and is adapted to attach to the head.

9. The key system of claim 8 wherein the head comprises at least one aperture positioned generally adjacent to the opening and the support base comprises at least one aperture that aligns with the aperture in the head when the projection is attached to the head, such that a fastener can be inserted through the aperture in the support base and into the head to secure the collar to the head.

10. The key system of claim 8 wherein the head comprises at least one aperture positioned generally adjacent to the opening and the support base comprises at least one aperture that aligns with the aperture in the head when the projection is attached to the head, such that a fastener can be inserted from inside the cavity through the aperture in the head and into the aperture in the support base to secure the collar to the head.

11. The key system of claim 8 wherein the projection is secured within the hollowed neck by attachment means such as adhesive, interference fit, welding, soldering, and/or brazing.

12. (canceled)

13. An interchangeable key head system comprising:
a head, wherein the head comprises a front surface and a back surface, a side surface that spans the periphery, a top end, a bottom end that is opposite the top end, a cavity in either the front or the back surface, and an opening in the side surface, at the bottom end, connecting to the cavity;
a blank comprising a blade at one end and a projection at an opposite end; and
a collar comprising a hollowed neck adapted to be secured to the projection, and an extension that is adapted to be inserted into the cavity through the opening and attached to the head; and
faceplates that may be attached to the front and back surfaces of the head.

14. The key system of claim 13 wherein the head further comprises at least one aperture in the base of the cavity, and the extension comprises at least one aperture.

15. The key system of claim 14 wherein the extension is inserted into the cavity so that the apertures in the extension align with the apertures in the head, such that a fastener can be placed through each aperture in the extension and into the head to secure the extension within the cavity.

16. The key system of claim 15 wherein the projection is secured within the hollowed neck by attachment means such as adhesive, interference fit, welding, soldering, and/or brazing.

17. The key system of claim 13 wherein the extension is secured within the cavity by attachment means such as adhesive, clamping, interference fit, welding, soldering, and/or brazing.

18. The key system of claim 17 wherein the projection is secured within the hollowed neck by attachment means such as adhesive, interference fit, welding, soldering, and/or brazing.

19. (canceled)
